(19) United States
(12) Patent Application Publication
(10) Pub. No.: US 2026/0137243 A1
(43) Pub. Date: May 21, 2026

(54) Q SET

(71) Applicant: ROBERT KESTER, Washington, MI (US)

(72) Inventor: ROBERT KESTER, Washington, MI (US)

(21) Appl. No.: 18/951,368

(22) Filed: Nov. 18, 2024

(51) Int. Cl. A47J 43/28; A47J 37/07; A47J 47/16

(52) U.S. Cl. CPC A47J 43/288; A47J 37/0786; A47J 43/283; A47J 47/16

(57) ABSTRACT

The present invention is (The Q Set) an ergonomic grilling utensil set designed to enhance comfort, stability, and functionality for users in both personal and commercial grilling environments. This set includes a spatula, tongs, a designer utensil base, each equipped with ergonomically contoured, heat-resistant handles to reduce hand fatigue and improve grip. The utensil handles feature a nicely sculpted designer LadyQ figure, while the utensil are constructed from high grade stainless steel for durability and resistance to high temperatures. A key component of the Q Set is its suction-based designer utensil storage base, which keeps utensils upright and accessible, reducing the risk of contamination. By combining comfort, durability, and adaptability, the Q Set provides a reliable and user-friendly solution to common grilling challenges.

### FIELD OF THE INVENTION

This invention relates to ergonomic cooking tools and, more specifically, to a set of grilling utensils designed for comfort, stability, and versatility in various grilling applications. The Q Set is particularly suited for use in home and outdoor grilling, providing a user-friendly and efficient experience.

### BACKGROUND OF THE INVENTION

In conventional grilling, users often experience discomfort and strain due to bulky, oversized, poorly designed utensils. Standard grilling tools are heavy and lack ergonomic considerations, which can result in hand fatigue, difficulty in maintaining control of food, and reduced precision during use. Additionally, many grilling sets are not built for durability or adaptability, limiting their effectiveness over time and in different grilling environments. The Q Set addresses these issues by providing an ergonomically stylish designed utensil set that offers comfort, stability, and versatility.

### Description of Prior Art

In many industrial, commercial, and personal applications, there is a need for a stable and secure base to support various items or equipment. Traditional weighted bases are commonly used to achieve this stability. However, many existing bases lack adaptability, secure adhesion to surfaces, and ease of repositioning. These conventional bases often rely solely on weight for stability, which limits their effectiveness on smooth or uneven surfaces where slippage may occur. Additionally, most existing utensil caddies do not offer customizable features that allow users to suction for stability according to specific needs. They also lack integrated fastening mechanisms (high strength suction cups) that enable secure attachment to other objects, making them less versatile in environments where equipment may be subject to movement or external forces. Some prior art includes bases with suction cups, but these are generally fixed, with limited durability and adaptability. The suction cups in existing designs are often prone to detachment under significant weight or force, limiting their reliability for applications requiring a stable, stationary platform. The Q Set addresses these limitations by combining a design with durable, high strength suction cups that secure the base to flat surfaces for added stability. This offers greater versatility, durability, and stability compared to existing solutions in the field.

### SUMMARY OF THE INVENTION

The Q Set is an innovative grilling utensil set designed to improve user comfort and efficiency during grilling regardless of the operator's physical strength or grilling expertise. The utensil enhances maneuverability and ease of use, especially beneficial to individuals who might find typical utensils cumbersome due to size and weight. Further, the utensil offers a lighter, compact, and easier to handle design to maintain better control over the grilling process while saving considerable time and effort for anyone cooking on a grill. Each utensil in the set is crafted with ergonomic handles that reduce hand fatigue, providing a comfortable and stable grip even during prolonged use. The handles are made from heat-resistant, non-slip materials that ensure safe and comfortable use around high temperatures. The set includes a durable, designer base that securely holds each utensil in place when not in use, reducing clutter and preventing the tools from coming into contact with surfaces that could compromise hygiene. The designer utensil base is equipped with four rubberized suction cups that allow it to adhere to smooth surfaces, offering stability during use and minimizing the risk of accidental movement. The utensils are made from high-grade, heat-resistant stainless steel, providing durability and resistance to rust and corrosion. Additionally, each utensil (tong-spatula) is detachable from the designer base for easy cleaning and storage, making the set not only ergonomic but also convenient and practical for regular use.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a diagram showing the right-side view of the current invention;

FIG. 2 is a diagram showing the top view of the current invention;

FIG. 3 is a diagram showing the split view (tong) of the current invention;

FIG. 4 is a diagram showing the front view of the current invention;

FIG. 5 is a diagram showing the back view of the current invention;

FIG. 6 is a diagram showing the right-side view of the invention;

FIG. 7 is a diagram showing the left side view of the current invention;

FIG. 8 is a diagram showing the top view of the current invention;

FIG. 9 is a diagram showing the bottom view of the current invention;

FIG. 10 is a diagram showing the top, front left side along with the bottom left side of the current designer utensil base assembly invention;

### DETAILED DESCRIPTION

The Q Set is a unique designer assembly of ergonomic grilling utensils designed to enhance comfort, stability, and usability for the user. This invention is a versatile set of tools specifically tailored to meet the needs of grilling enthusiasts, both in casual and professional settings. Each component within the set is crafted with careful attention to user experience, ensuring that the utensils are functional, easy to handle, and safe for high-heat environments. The utensil set includes a designer utensil base, along with a spatula and tong, each designed with ergonomically contoured handles that reduce hand fatigue during prolonged use. These handles are made from heat-resistant materials that withstand high temperatures commonly associated with grilling. This design prioritizes user comfort by allowing for a firm, secure grip that helps prevent slippage and accidental dropping, even in greasy or wet conditions. The handles'shapes are tailored to the contours of the human hand, making them comfortable to hold for extended periods. The materials used in the construction of the utensil are high-grade, rust-resistant stainless steel, which combines lightweight durability with resistance to the wear and tear associated with frequent exposure to food, grease, and heat. The design of the utensils is optimized for functionality: the spatula has a broad, flat surface for flipping and pressing, the tongs provide a strong grip with minimal effort. Phase two of LadyQ will consist of additional barbeque products at a later date.

One of the distinctive features of the Q Set is the inclusion of a designer base that serves as both a storage and organizational component. This base is constructed to provide stability, with a design that keeps the utensils upright, thereby reducing the risk of contamination when they are not in use. The base incorporates suction cups that adhere securely to flat surfaces. These suction cups provide additional stability, ensuring that the base does not move or tip over during use or in windy outdoor conditions. This stable storage solution keeps each utensil readily accessible while cooking, minimizing interruptions and enhancing efficiency for the user. This capability makes the Q Set adaptable to various settings, from backyard gatherings to professional food preparation areas.

Furthermore, the Q Set is designed to be both aesthetically pleasing and highly functional. The materials used are not only durable but also lend the utensils a sleek, modern appearance that complements the overall look of outdoor and indoor cooking setups. Each component has been carefully chosen and crafted to ensure that it can withstand rigorous use while remaining easy to clean and maintain.

The combination of ergonomic handles, heat-resistant materials, and a stable base make the Q Set an innovative solution in the grilling utensil market. By focusing on user comfort, ease of use, and adaptability to different environments, the Q Set meets a range of grilling needs, providing users with a high-quality, reliable, and stylish grilling tool set that enhances their cooking experience.

The terms “a” and “an” herein do not denote a limitation of quantity, but rather denote the presence of at least one of the referenced items.

The terminology used herein is to describe particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

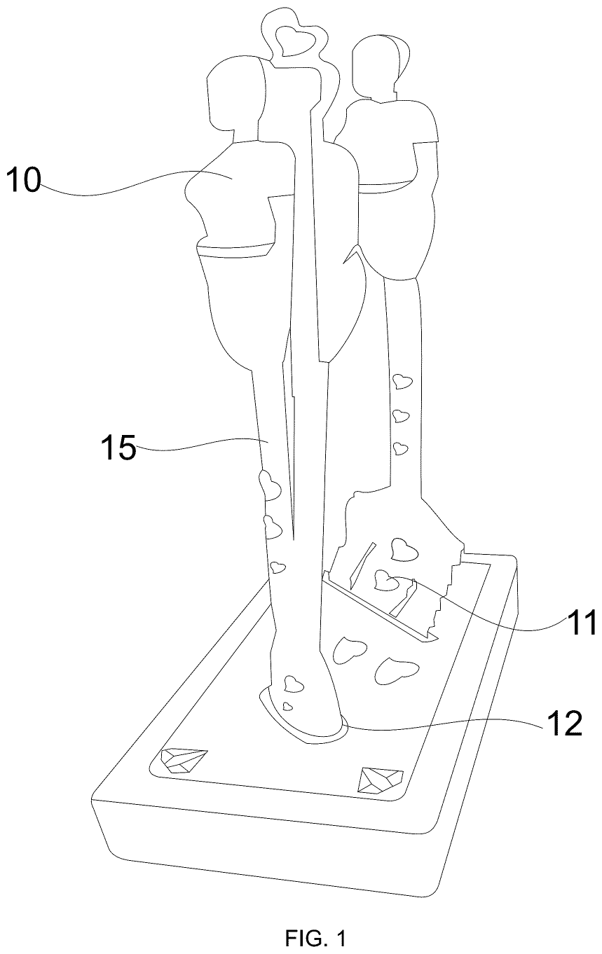

The present invention is presented in terms of its preferred embodiment, herein depicted within FIG. 1 through FIG. 9. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one particular configuration shall be shown and described for purposes of clarity and disclosure and not by way of limitation of scope.

FIG. 1 demonstrates the Q Set in a practical setting. The figure highlights the utensil heads (10), including the spatula (11), the designated slot for each utensil (12), and the tong (15), all arranged on the designer utensil base. This configuration illustrates the organized placement and usability of the Q Set during grilling.

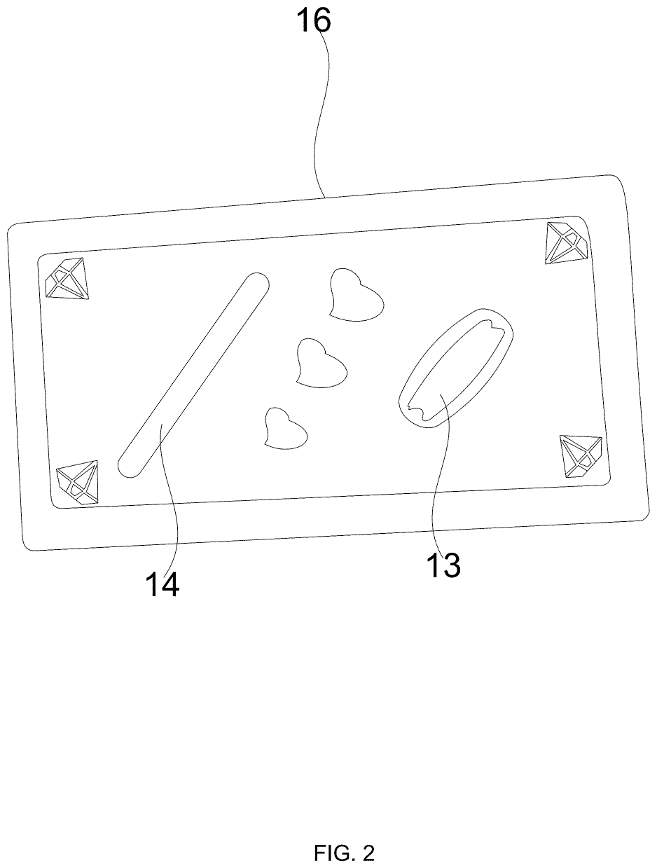

FIG. 2 presents the weighted base (16) in isolation, emphasizing the stability provided by the TPU 80 rubber inserts (13 and 14). The figure also highlights the functional arrangement of the utensils and their secure positioning within the slots, showcasing the design's focus on organization and ease of access.

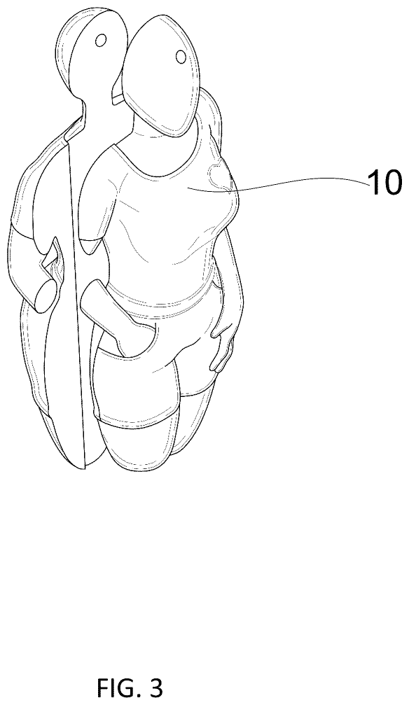

FIG. 3 shows the tong handle from a perspective angle, emphasizing its ergonomic design and the smooth, secure connection to the tong.

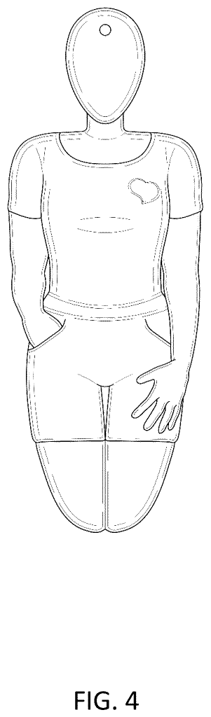

FIG. 4 presents the spatula handle from the front angle, illustrating the sturdy construction that allows for easy cleaning and versatility.

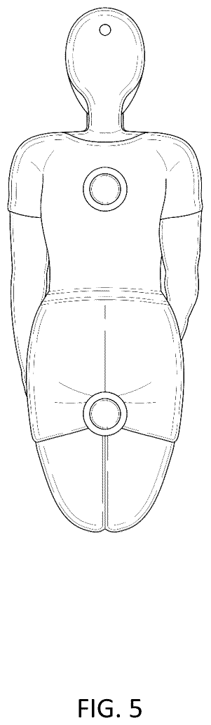

FIG. 5 highlights the angle and attachment of the tong handle from the back, focusing on the ergonomic design that enhances grip and ease of use during grilling.

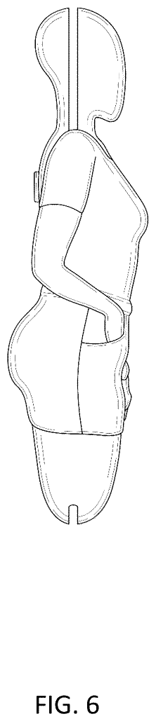

FIG. 6 presents the spatula handle from the right side angle, highlighting its durable construction, which allows for easy cleaning and versatility during grilling.

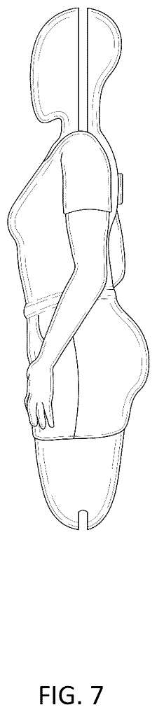

FIG. 7 shows the spatula handle from the left side angle, emphasizing its ergonomic design and the smooth, secure connection to the handle.

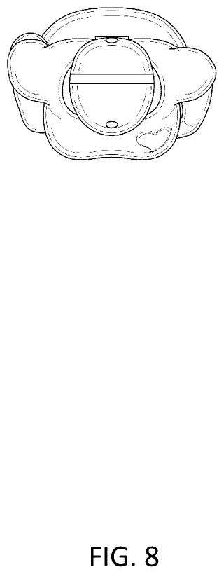

FIG. 8 presents the spatula handle from a the top, highlighting its durable construction, which allows for easy cleaning and versatility during grilling.

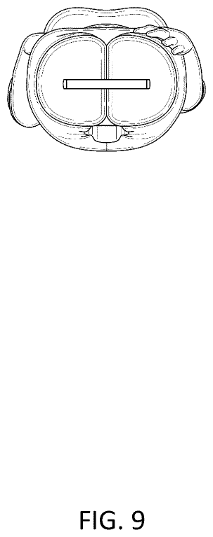

FIG. 9 provides a view of the spatula handle from the bottom, highlighting its ergonomic shape that offers a comfortable, secure grip, making it ideal for grilling tasks

FIG. 10 provides a view of the designer utensil base from the top and the bottom, highlighting the suction cups

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

The Abstract of the disclosure is provided to allow the reader to quickly ascertain the nature of the technical disclosure. It is submitted with the understanding that it will not be used to interpret or limit the scope or meaning of the claims. Also, in the foregoing detailed description, it can be seen that various features are grouped in various embodiments to streamline the disclosure. This method of disclosure is not to be interpreted as reflecting an intention that the claimed embodiments require more features than are expressly recited in each claim. Rather, as the following claims reflect, the inventive subject matter lies in less than all features of a single disclosed embodiment.

### I. Terms

The term “invention” and the like mean “the one or more inventions disclosed in this application”, unless expressly specified otherwise.

The terms “an aspect”, “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “e.g.” and like terms mean “for example”, and thus does not limit the term or phrase it explains.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

Neither the Title (set forth at the beginning of the first page of the present application) nor the Abstract (set forth at the end of the present application) is to be taken as limiting in any way as the scope of the disclosed invention(s). An Abstract has been included in this application merely because an Abstract of not more than 150 words is required under 37 C.F.R. .sctn. 1.72(b). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

### II Overview

The present invention, The Q Set is an innovative designer base designed to provide enhanced stability, versatility, and adaptability across a wide range of applications. Unlike traditional bases, which rely solely on weight for stability, The Q Set integrates high strength suction cups which allows it to securely support LadyQ's designer utensils in environments where stability and security are essential. The Q Set's unique design incorporates four strategically positioned suction cups, which provide a firm grip on smooth surfaces, preventing unwanted movement. This feature makes The Q Set ideal for use on flat surfaces where traditional bases might slide or shift. Crafted from durable, impact-resistant materials, The Q Set is built to withstand various environmental conditions, ensuring long-lasting performance both indoors and outdoors. Its compact, portable design makes it convenient for users who need a stable base that can be easily transported and repositioned. The Q Set addresses the limitations of conventional bases by offering a more flexible, user-friendly solution that can be tailored to meet the specific needs of diverse applications. Its innovative features and robust construction make it a reliable choice for industrial, commercial, and personal use cases, where stability, ease of use, and durability are of utmost importance.

The primary function of The Q Set is to provide a stable, versatile, and adaptable designer base that securely anchors the utensils on smooth surfaces, reducing the risk of movement, slipping, or tipping. It accomplishes this by combining a structure that securely adheres to flat surfaces for enhanced stability. This innovative design enables The Q Set to serve as a reliable foundation across diverse applications, accommodating multiple surface needs for stability in industrial, commercial, and personal settings.

1. A set of ergonomic grilling utensils, comprising a spatula, tongs, and a designer utensil base, each utensil designed for ease of handling and lightweight functionality, with handles made of high-temperature silicone to offer comfort, control, and thermal protection for users.

2. The spatula of the set as claimed, featuring a curved blade with ridged edges, enabling easy flipping and secure handling of food items while maintaining a lightweight structure to enhance maneuverability during grilling.

3. The tongs of the set as claimed, constructed with an ergonomic handle design and made of high-strength, corrosion-resistant materials, including 304 stainless steel or a treated magnesium alloy, providing strength, durability, and resistance to high temperatures.

4. The designer utensil base of the set as claimed, crafted from high-grade material and color-matched to the utensil handles, configured to allow upright storage of the utensils, thereby serving as a compact, aesthetic display solution that minimizes required storage space.

5. The set as claimed, wherein each utensil includes a laser etched LadyQ logo below the handle, with three bubbled-up hearts polished to a chrome look, providing an elegant appearance, and the hearts also serve as grease-release cutouts in the lower portion of the utensils.
